(19) United States
(12) Patent Application Publication
(10) Pub. No.: US 2023/0311468 A1
(43) Pub. Date: Oct. 5, 2023

(54) MULTILAYER BODY AND METHOD FOR PRODUCING A MULTILAYER BODY

(71) Applicant: LEONHARD KURZ Stiftung & Co. KG, Fürth (DE)

(72) Inventors: Uwe REUTHER, Nürnberg (DE); Roman LASCH, Fürth (DE); Annie KUSCHEL, Fürth (DE)

(21) Appl. No.: 18/021,648

(22) PCT Filed: Aug. 4, 2021
(86) PCT No.: PCT/EP2021/071752

§ 371 Date: Feb. 16, 2023

(30) Foreign Application Priority Data
Aug. 20, 2020 (DE) 10 2020 121 896.6

(51) Int. Cl. B32B 29/00; B32B 7/12

(52) U.S. Cl. CPC B32B 29/005; B32B 7/12; B32B 2250/03; B32B 2250/26; B32B 2307/412; B32B 2307/718; B32B 2250/05; B32B 2307/4026; B32B 2307/7376; B32B 2307/538; B32B 2307/406; B32B 2255/12; B32B 2307/554; B32B 2451/00; B32B 2255/26

(57) ABSTRACT

A multilayer body (1), in particular a laminate, and a method for producing a multilayer body (1). The multilayer body (1) includes a substrate (10), at least one decorative ply (30) and at least one protective ply (20). The at least one protective ply (20) has at least one adhesive layer (22) and at least one protective layer (21), wherein the at least one protective layer (21) includes or consists of paper, in particular transparent paper.

The invention relates to a multilayer body, in particular a laminate, and a method for producing a multilayer body.

It is known that highly transparent plastic layers are applied to decorated substrates so that they protect the decoration from chemical, physical and/or mechanical influence. A further object of the highly transparent plastic layers is that the decoration lying underneath them continues to be very easily visible for an observer.

For a good resistance, in particular to mechanical influence, the plastic layer has a high adhesion to the substrate. For a good visibility of the decoration it is also necessary for the applied plastic layer to be in contact with the decoration over the whole surface, in order for example to prevent bubbles or other inclusions.

However, this in turn has the result that at the end of a product life cycle it is not possible or is very complex to separate the different materials applied to each other. Thus, such multilayer bodies are only poorly or not at all recyclable, however.

The object of the invention is now to specify an improved multilayer body and an improved method for producing a multilayer body, wherein the improved multilayer body and the improved method are in particular to avoid the disadvantages of the state of the art.

The object is achieved by a multilayer body, in particular a laminate, comprising a substrate, at least one decorative ply and at least one protective ply, wherein the at least one protective ply has at least one protective layer and at least one adhesive layer, and wherein the at least one protective layer comprises or consists of paper, in particular transparent paper.

This object is further achieved by a method for producing a multilayer body, in particular according to one of claims 1 to 59, wherein the method comprises the following steps, which are carried out in particular in the following order:
a) preparing a substrate provided with at least one decorative ply,
b) preparing at least one protective ply, wherein the protective ply comprises at least one protective layer and at least one adhesive layer, wherein the at least one protective layer comprises or consists of paper, in particular transparent paper,
c) applying the at least one protective ply to the substrate provided with the at least one decorative ply, in particular to obtain the multilayer body.

Through the invention, the advantage is achieved that a multilayer body is obtained which has an increased recyclability, as a paper, in particular transparent paper, is applied to the decoration instead of a highly transparent plastic layer. The paper, in particular transparent paper, here undertakes the task of protecting the decoration from chemical, physical and/or mechanical influence. The paper, in particular transparent paper, can additionally be detached from the decoration in comparatively simple chemical and/or physical and/or mechanical processes and fed into the paper recycling stream. The protective layer made of paper, in particular transparent paper, or the protective ply can preferably remain on the substrate, in particular if the substrate itself also consists of or substantially comprises paper and/or cardboard and/or card. The protective layer made of paper, in particular transparent paper, or the protective ply can preferably also be detached from the substrate before and/or during the recycling, in particular if the substrate does not consist of or substantially comprise paper and/or cardboard and/or card.

The use of a paper, in particular transparent paper, further results in the surprising effect that the visual appearance of the decoration changes fundamentally. In particular, this is to be attributed to the fact that a paper, in particular transparent paper, as a rule has a lower transparency or a lower transmittance and a greater cloudiness than a plastic layer, wherein irradiating or incident light is diffusely scattered.

Thus, for example, transparent paper is almost invisible for the observer and gives the decoration the character of a paper. On the one hand, this is related to the visual appearance. On the other hand, however, the feel also changes and the multilayer body feels as if it were made of paper or free of “plastic”. A decoration lying behind the paper, in particular transparent paper, further appears more matte and less brilliant. In other words, a soft-focus effect arises, through which comparatively low-contrast surface areas form which allow for example the surface of a multilayer body according to the invention to appear to be of very high quality and precious. Depending on the type of paper, in particular the transparent paper, and the decoration, a large number of different optical decorations are achievable. Thus, for example, a paper, in particular transparent paper, with a particularly high minimum transparency and as low as possible a cloudiness and surface roughness generates an almost clear appearance of the decoration, which bears similarity to that of a decoration provided with a conventional plastic layer. Alternatively, for example, a greater cloudiness generates a “soft”, slightly fuzzy impression, which conveys an additional optical depth, and/or “foggy” impression.

By paper is preferably meant a flat material with a grammage of from 7 g/m₂ to 225 g/m₂, which is produced from pulp and in particular is obtained by removing water from a fiber suspension. In particular, paper comprises plant fibers, cellulose, wood pulp and/or recycled fiber.

By card is preferably meant paper with a grammage of from 150 g/m₂ to 600 g/m₂. Furthermore, by cardboard is preferably meant paper with a grammage of from 225 g/m₂. It is thus possible for a material which, because of its grammage, lies in an overlapping range to be able to be assigned to several terms.

By transparent paper is preferably meant paper which appears transparent due to a high transmittance, preferably due to a transmittance of over 50%, further preferably of over 70%, in particular in the wavelength range of between 300 nm and 780 nm. Transparent papers comprise for example tissue papers, impregnated papers, vegetable papers and/or glassine.

By transmittance is preferably meant the ratio of the quantity of a light irradiating and/or incident on a medium to the quantity of light which emerges on the opposite side of the medium, wherein in particular no change in the frequency or the wavelength of the light has taken place. The light not transmitted is preferably reflected, scattered and/or absorbed by the medium. Thus, for example, in the case of a transmittance of a medium of 0.7 or 70%, 70% of the irradiating light is perceptible on the opposite side of the medium.

In the case of a transmittance in the range of from 50% to 99%, the medium is preferably understood as transparent. Further preferably, in the case of a transmittance in the range of from 30% to 50% the medium is preferably understood as translucent and in the case of a transmittance in the range of from 0% to 30% the medium is understood as opaque. The transmittance is thus to be understood in particular as a material property.

Further advantageous designs of the invention are described in the dependent claims.

Preferable embodiments of the substrate are described in the following:

The substrate preferably forms the bottom ply of the multilayer body in a top view. In other words, in a top view the at least one decorative ply and/or the at least one protective ply is preferably arranged on the substrate, so that the substrate preferably forms the back of the multilayer body. By top view is preferably meant the viewing direction of an observer which is directed perpendicularly onto the surface of the plane spanned by the multilayer body and/or a ply. This means that the observer here looks in particular onto the visible side of the multilayer body.

In particular, it is advantageous if the substrate is formed translucent or opaque and/or dyed or at least partially dyed.

The substrate preferably comprises a material which is selected from the group which consists of paper, card, cardboard, preferably paper, card, and further preferably coated graphic paper, uncoated graphic paper, coated paper for packaging, uncoated paper for packaging, coated card, uncoated card, and mixtures thereof. A substrate made of such a material as paper, card, cardboard can advantageously be fed into the paper recycling stream together with the protective layer made of paper, in particular transparent paper, or the protective ply in comparatively simple chemical and/or physical and/or mechanical processes, without the need to effect a separation of the protective layer made of paper or the protective ply from the substrate.

The substrate is preferably referred to as coated when a binder has been deposited on its surface. In the process unevennesses are preferably leveled out, the surface is mechanically stabilized and smoothed, and the printability is improved. Further, the binder can contain colored pigments. The substrate can in particular appear matte, semi-matte or glossy due to the binder. Uncoated substrates have in particular no such binder coat.

Such a design of a multilayer body further improves its recyclability, in particular compared with multilayer bodies made of a pure plastic laminate. The protective layer made of paper, in particular transparent paper, or the protective ply can remain on the substrate, in particular if the substrate itself also consists of or substantially comprises paper and/or cardboard and/or card. The protective layer made of paper, in particular transparent paper, or the protective ply can preferably also be detached from the substrate before and/or during the recycling, in particular if the substrate does not consist of or substantially comprise paper and/or cardboard and/or card. The decorative ply is in particular designed so thin that it does not interfere with the recyclability of the multilayer body and accordingly the multilayer body can be fed in its entirety into the paper recycling stream, in particular if the substrate itself also consists of or substantially comprises paper and/or cardboard and/or card. Alternatively, the at least one decorative ply can preferably be removed from the substrate and/or from the at least one protective ply, and then the substrate can be fed into the paper recycling stream.

The substrate preferably has a grammage in the range of from 50 g/m₂ to 500 g/m₂. The multilayer body hereby achieves a sufficient mechanical stability and an associated quality.

Further, it is advantageous if the substrate comprises at least one optical coat. Further preferably, the at least one optical coat is attached at least to the substrate side which faces the at least one decorative ply. Still further preferably, a further optical coat is also attached to the substrate side which faces away from the at least one decorative ply. An individual design of the substrate is thereby possible, and it obtains a high-quality optical, but also haptic, impression.

The at least one optical coat is preferably dyed, in particular by means of dyes and/or pigments, wherein the pigmentation level of the at least one optical coat is preferably less than 50%, preferably less than 40%, further preferably less than 30%.

By the pigmentation level is preferably meant the percentage of dyes and/or pigments with respect to the total mass of an applied and preferably dried layer, ply and/or film.

It is also possible for the at least one optical coat to be colorless and/or to be clearly transparent and/or for the pigmentation level of the at least one optical coat to be less than 5%.

Further, it is also possible for the at least one optical coat to have a gloss value of more than 50 GU, preferably of more than 60 GU, preferably at a measurement angle of 60°, under light, in particular light in the wavelength range of between 300 nm and 780 nm. With respect to the meaning of the gloss value in gloss units [GU], reference is made here to the following statements.

The substrate preferably has a surface smoothness in the range of from 0.5 μm to 8.0 μm, preferably in the range of from 1.0 μm to 3.0 μm, in particular measured using the Parker Print-Surf method (PPS method) according to DIN ISO 8791-30 4:2008-05 (“Paper and board—Determination of roughness/smoothness (air leak methods)—Part 4: Print-surf method”, issue date: 2008-05), and/or a surface smoothness in the range of from 50 ml/min to 900 ml/min, preferably in the range of from 100 ml/min to 400 ml/min, in particular measured using the Bendtsen method according to DIN ISO 8791-2:2013-09 (“Paper and board—Determination of roughness/smoothness (air leak methods) Part 2: Bendtsen method”, issue date: 2013-09). A corresponding surface smoothness on the one hand makes an improved adhesion of the further layers to the substrate possible and on the other hand allows the substrate to appear to be of high quality.

By surface smoothness or surface roughness is preferably meant a value for the structure of a surface, which can be determined for example indirectly by measuring an airflow between a diaphragm and the substrate surface. Examples of such indirect measurement methods are the Parker Print-Surf (PPS) or the Bendtsen method.

By the PPS method is preferably meant a method in which a quantity of air which is pressed through a gap between a measuring ring and a substrate lying on a hard rubber plate is measured. The measuring surface used is preferably 98 mm long, designed annular and 51 μm wide. The measurement result of the surface smoothness according to the PPS method is preferably indicated in the unit [μm].

By the Bendtsen method is preferably meant a method in which air is pressed through a gap between a substrate lying on a glass plate and a ring lying on that. The ring preferably has an inside diameter of 31.5 mm and a wall thickness of 150 μm. The volume of air escaping per minute is measured. The measurement result of the surface smoothness according to the Bendtsen method is preferably indicated in the unit [ml/min].

Preferably, coated substrates are measured with the PPS method and uncoated substrates are measured with the Bendtsen method.

Embodiments of the at least one decorative ply are described in the following:

In a particularly preferred embodiment the at least one decorative ply is attached between the substrate and the at least one protective ply.

Further, it is provided in particular that the at least one decorative ply has at least one protective varnish layer and/or at least one decorative layer and/or at least one functional layer and/or at least one primer layer and/or at least one adhesive layer and/or at least one color layer.

It is further provided in particular that the at least one decorative ply, as a transfer ply, is a constituent of a transfer film, wherein the transfer film has a carrier ply and preferably at least one detachment layer. In particular, it is provided that the carrier ply of the transfer film is peeled off the transfer ply during the application of the transfer film to the substrate. In other words, the at least one decorative ply at least partially remains on the substrate.

Further, it is also possible for the multilayer body to have at least two decorative plies, which preferably differ in terms of their properties, further preferably in terms of their optical properties and/or their layer structure.

This means that the at least two decorative plies preferably in each case comprise at least one protective varnish layer and/or at least one decorative layer and/or at least one functional layer and/or at least one primer layer and/or at least one adhesive layer and/or at least one color layer, and further preferably are designed according to the embodiments of the at least one decorative ply.

In particular, it is possible for at least two, in particular differing, decorative plies to be present next to each other, preferably viewed in a top view. It is also possible for at least two, in particular differing, decorative plies to be present one over another and/or overlapping at least in areas, preferably viewed in a top view.

By area is meant here in particular in each case a defined surface area of a layer or ply which is occupied when viewed perpendicular to a plane, spanned in particular by substrate, decorative ply and/or protective ply.

It is provided in particular that the at least one decorative ply has a thickness in the range of from 1.0 μm to 5 μm, in particular of from 1.0 μm to 2 μm. It has been shown that in the case of such a layer thickness the decorative plies break particularly well at the predefined edges. A clean decoration of the decorative ply on the substrate can thus be achieved.

In particular, the carrier ply comprises a material or a combination of materials selected from: PET, PMMA, PC, PE, PVC, PS, ABS, PU, PBS, PLA, PAN and/or glass and/or paper and/or hybrid materials.

Carrier plies made of the above-named material can be recycled well after being detached and thus reduce the quantity of waste materials which accumulate due to the production of the multilayer body.

The at least one detachment layer preferably comprises a material or a combination of materials selected from: waxes, silicones, polyurethanes and/or polymers, preferably acrylate copolymer, polyester copolymers, polystyrene copolymers, polycarbonate copolymers.

The at least one detachment layer preferably has a thickness in the range of from 0.01 μm to 0.50 μm. This comparatively small thickness of the detachment layer allows a sharp-edged and clean detachment of the decorative ply from the carrier ply. The accuracy achievable here and the resolution achievable here can correspond comparatively accurately to the layout of the partially applied, preferably to the substrate, at least one adhesive layer, without deviating significantly therefrom, as a result of which a high register accuracy of the film layout or the film plane relative to a possibly present print layout or a possibly present print plane consisting of conventional printing inks is achievable. In other words, it is preferred that the at least one decorative ply is applied register-accurately to the substrate.

By register or registration, or register accuracy or registration accuracy, is preferably meant a positional accuracy of two or more elements and/or layers.

The register accuracy is to range within a predefined tolerance which is to be as small as possible. At the same time, the register accuracy of several elements, layers, areas or partial areas relative to each other is an important feature in order to increase the process reliability.

The positionally accurate positioning is effected in particular by means of markings, in particular by means of sensorily, preferably optically, detectable registration marks or register marks. These markings, in particular registration marks or register marks, preferably either represent special separate elements, areas or layers or are preferably themselves part of the elements, areas or layers to be positioned.

During this sharp-edged partial detachment, due to the small thickness of the detachment layer, only very small and very few so-called flakes form, thus small layer residues of the decorative ply, which can be disruptive in subsequent process steps and/or can disrupt the optical appearance of the coated target substrate. It is hereby possible for resolutions which preferably lie below the resolving power of the human eye to be achievable due to the comparatively small thickness of the detachment layer.

In particular, it is advantageous if the at least one detachment layer is formed transparent or translucent or opaque and/or dyed or at least partially dyed and/or crystal clear.

The at least one decorative ply preferably has at least one protective varnish layer.

Further preferably, the at least one protective varnish layer comprises a material or a combination of materials selected from: polymers, in particular acrylate copolymers, polyester copolymers, polystyrene copolymers, polycarbonate copolymers and/or SMA copolymers (SMA=styrene maleic anhydride).

The at least one protective varnish layer preferably has a thickness in the range of from 0.5 μm to 3 μm, in particular of from 0.8 μm to 1.3 μm.

Alternatively, the protective varnish layer can act as a detachment layer. The force of detachment of the protective varnish layer from the carrier ply preferably lies between 5 cN and 45 cN, further preferably between 10 cN and 30 cN.

It is preferably possible for the at least one protective varnish layer to be formed transparent or translucent or opaque and/or dyed or at least partially dyed and/or crystal clear.

The at least one protective varnish layer in particular represents a protection from mechanical and/or chemical stress of the at least one decorative ply on the substrate.

The at least one decorative ply preferably has at least one functional layer.

The at least one functional layer preferably has a thickness in the range of from 10 nm to 1500 nm, preferably of from 20 nm to 1000 nm, in particular preferably of from 50 nm to 500 nm.

The at least one functional layer can be constructed multilayered and in particular have layers which can be present in each case over the whole surface or only partially, selected individually or in combination from: electrically conductive layer, magnetic layer, stabilizing layer, adhesion-promoter layer, detachment layer, electromagnetic radiation shielding layer, masking layer, color layer, barrier layer.

It is provided in particular that the at least one decorative layer of the at least one decorative ply comprises at least one metallic layer and/or at least one dielectric layer.

The at least one decorative layer preferably has a thickness in the range of from 8 nm to 1000 nm, preferably of from 8 nm to 200 nm, in particular preferably of from 10 nm to 100 nm.

In order, when a UV adhesive is used as cold glue, to achieve the desired high UV transmissibility of the at least one decorative ply also in the case of at least one decorative layer in the form of a metallic layer, it is particularly preferred if the metallic layer has a layer thickness in the range of from 8 nm to 60 nm, preferably in the range of from 10 nm to 30 nm.

Thus, a good visibility and decorative effect of the metallic layer in combination with a high transmissibility for UV radiation are achieved, wherein the at least one metallic layer preferably has an OD of 1.2 (OD=optical density).

In order to achieve a sufficient curing of a UV adhesive, it is provided in particular that the at least one decorative layer has a transmissibility for UV radiation, in particular for the wavelength range of from 250 nm to 400 nm, in the range of from 5% to 70%, in particular of from 10% to 40%. A particularly rapid and in particular sufficient curing of a cold glue based on a glue that crosslinks under UV irradiation on the substrate thereby becomes possible, as a result of which the adhesion of the at least one decorative ply to the substrate is improved still further. This is because only when the irradiation quantity is high enough is the glue that crosslinks under UV irradiation preferably completely crosslinked and fully cured and achieves a high adhesive force, with the result that the decorative ply areas transferred to the substrate are reliably prevented from detaching from the substrate. A determining factor for the UV transmissibility of a decorative ply here is preferably the layer of a decorative ply which has the lowest UV transmissibility of all layers present.

It is provided in particular that the at least one metallic layer comprises a material or a combination of materials selected from: aluminum, silver, gold, copper, nickel, chromium, indium, tin and/or an alloy comprising at least two of these metals.

The at least one dielectric layer preferably comprises a material or a combination of materials selected from: metal oxide, polymer, varnish, HRI material (HRI=High Refractive Index), in particular MgO, TiOₙ, Al₂O₃, ZnO, ZnS and/or SiOₙ, wherein n preferably comprises the range of from 1 to 3.

It is provided in particular that the at least one decorative layer is formed of an HRI material, preferably CdSe, CeTe, Ge, HfO₂, PbTe, Si, Te, TiCI or ZnTe, which is in particular radiolucent at least for partial ranges of the spectrum in the UV range, in particular for the wavelength range of from 250 nm to 400 nm.

In particular, it is further possible for the at least one decorative layer to have at least one layer generating an optically variable effect.

It is provided in particular that the at least one decorative layer has at least one replication varnish layer with a surface structure molded into the at least one replication varnish layer, in particular wherein the surface structure molded into the at least one replication varnish layer is selected from: diffractive surface structure, refractive surface structure, lens structure, matte structure, blazed grating.

By a replication varnish layer is preferably meant here a special, functional layer in which optically variable structures are introduced and/or fixed in particular by means of thermal replication and/or UV replication. A replication varnish layer is in particular a hybrid layer, which is for example thermally replicated and then cured by means of radiation, for example by means of UV radiation, in particular in the wavelength range of from 250 nm to 400 nm, and/or at least one electron beam. For example, it is possible for the one replication varnish layer to become warm during a UV replication.

It has proved worthwhile if the at least one decorative layer has a diffractive and/or refractive relief structure for generating optically variable effects and/or a macrostructure for generating three-dimensional effects or depth effects. Through diffractive and/or refractive relief structures, which are formed in particular in a transparent varnish layer or replication varnish layer, different optical effects, so-called optically variable effects, can be achieved depending on the viewing angle, such as holograms, three-dimensional representations with kinematic effect dependent on the viewing angle, etc.

In order to improve the visibility of relief structures, these are usually arranged adjoining a strongly reflective metallic layer and/or dielectric HRI layer with a comparatively high to very high refractive index, in particular consisting of a metal oxide. Such a highly reflective layer is preferably formed over the whole surface or patterned.

Furthermore, it is also preferably provided that the at least one decorative layer is designed with optically variable pigments, luminescent substances, magnetic or electrically conductive substances, a color layer, a thin-film stack with interference color effect dependent on the viewing angle, a liquid-crystal layer, or also a combination of above-named layers comprising metallic layers, dielectric layers etc.

The at least one decorative layer preferably has at least one, preferably patterned, reflective layer, further preferably designed in the form of a first item of information.

In particular, the at least one decorative layer has at least one thin-film layer element for generating a color shift effect dependent on the viewing angle.

It is also preferably possible for the at least one decorative ply to have at least one, preferably patterned, color layer, further preferably shaped in the form of a second item of information. The second item of information can be identical to, in particular congruent with, the first item of information. The second item of information can alternatively be different from the first item of information.

By information is meant in particular the representation of one of the following design elements or a combination of the following design elements: alphanumeric character, character, symbol, microprint, image, motif, photo, logo, portrait, pictogram. Further, it possible for the information to be represented in the form of an endless pattern and/or a grid, in particular a periodic grid, aperiodic grid, random grid, amplitude-modulated grid, dot grid, line grid.

Further, it is preferred that the at least one color layer is dyed by means of dyes and/or pigments, wherein the pigmentation level of the at least one color layer is preferably between 1% and 50%, preferably between 10% and 30%.

In particular, it is preferred that the at least one color layer has a layer thickness of between 0.5 μm and 10 μm, preferably between 1 μm and 5 μm. It is further preferred that the at least one color layer is deposited as a varnish and the preferred layer thickness is understood as the dry layer thickness.

It is particularly preferred that the at least one color layer is multilayered, in particular that the at least one color layer is formed of two or more partial layers, wherein the two or more partial layers preferably in each case have a layer thickness of between 0.1 μm and 2 μm, further preferably between 0.3 μm and 1 μm.

Furthermore, it is also possible for the at least one color layer to be formed over the whole surface, in particular for the at least one color layer to occupy the entire surface area of the decorative ply when viewed in a top view.

It is also preferred that the at least one color layer has a transmittance of more than 10%, preferably of more than 25%, further preferably of more than 50%, still further preferably of more than 75%, furthermore still further preferably of more than 90%, in particular in the wavelength range of between 300 nm and 780 nm.

In particular, it is also possible for the at least one color layer to be an overprint. This means that the at least one color layer is applied as an overprint, in particular to at least one of the further layers comprised by the decorative ply. The color layer is preferably applied as an overprint after the further layers comprised by the decorative ply have already been applied to the substrate.

It is further preferably provided that the force of adhesion between the at least one color layer and the at least one decorative ply is at least 25 cN, preferably at least 30 cN.

The at least one decorative ply preferably has at least one primer layer.

It is further preferably provided that the at least one primer layer has a thickness in the range of from 0.1 μm to 2 μm, preferably of from 0.2 μm to 1 μm, further preferably of from 0.2 μm to 0.8 μm.

In particular, the at least one primer layer is formed transparent or translucent or opaque and/or dyed or at least partially dyed and/or crystal clear. In particular if the at least one primer layer is formed at least partially dyed or dyed, the contrast to the substrate is increased and a particularly high-quality optical impression or effect is brought about.

It is further preferably provided that the at least one primer layer has a surface roughness in the range of from 100 nm to 200 nm, preferably of from 120 nm to 160 nm. The surface roughness is determined among other things by the method of deposition and the formulation of the primer layer. It has been established that a smaller surface roughness, but surprisingly also a greater surface roughness, of the primer layer results in a reduction of the adhesion achievable between a cold glue and the transfer ply or decorative ply. The surface roughness of the primer layer was determined by means of interference microscopy.

In addition, it is possible for example for the at least one decorative ply to comprise several primer layers, which can be different in terms of their chemical and/or physical properties, with the result that a sufficient adhesion to the layers adjoining the primer layer, in particular to an adjoining adhesive layer, is formed. Thus, it is possible for example to achieve a sufficient adhesion in the direction of the at least one decorative layer on one side of the primer layer and a sufficient adhesion in the direction of the at least one adhesive layer on the other side of the primer layer.

In a preferred embodiment, it is possible for the at least one adhesive layer of the at least one decorative ply and the at least one adhesive layer of the at least one protective ply to be different in terms of their chemical and/or physical properties.

Here, an optimum adhesion to the adjoining layers, which can consist of different materials, is formed. Thus, it is possible for example to achieve an optimum adhesion of the at least one protective ply to the at least one decorative ply through the at least one adhesive layer of the at least one protective ply. Further, it is possible for example to achieve an optimum adhesion of the at least one decorative ply to the substrate through the at least one adhesive layer of the at least one decorative ply.

It is provided in particular that the at least one adhesive layer of the at least one protective ply covers the at least one decorative ply at least in areas at least partially or over the whole surface.

It is provided in particular that the at least one adhesive layer of the at least one decorative ply and/or the at least one adhesive layer of the at least one protective ply comprises several adhesive layers which are different in terms of their chemical and/or physical properties.

The at least one adhesive layer of the at least one protective ply preferably does not cover the decorative ply at least in areas or covers it at least partially or over the whole surface.

It is preferably provided that at least one area is patterned, in particular in the form of at least one of the following design elements or a combination of the following design elements: alphanumeric character, character, symbol, microprint, image, motif, photo, logo, portrait, pictogram. Further, it possible for an area to be designed in the form of an endless pattern and/or a grid, in particular a periodic grid, aperiodic grid, random grid, amplitude-modulated grid, dot grid, line grid.

It is preferably also possible for the at least one adhesive layer of the at least one decorative ply and/or the at least one adhesive layer of the at least one protective ply to be formed of a hot glue and/or a thermoplastic adhesive and/or a cold glue and/or a radiation-curable adhesive, in particular an adhesive that can be cured by means of electromagnetic radiation and/or electron beam radiation and/or by means of UV radiation, and/or an oxidatively curing adhesive and/or a low-migration adhesive (LMI adhesive, LMI =low migration ink).

The at least one adhesive layer of the at least one decorative ply preferably comprises in particular polyester copolymers, acrylate copolymers, polyvinyl chlorides, chlorinated polyolefins, ketone-aldehyde resins, colophony resins, hydrocarbon resins, polyamide resins.

It is also preferred that the at least one adhesive layer of the at least one decorative ply and/or the at least one adhesive layer of the at least one protective ply comprises or consists of polyester resins. For example, the adhesive layer of the protective ply comprises one of the following polyester resins and/or combinations thereof: Danpol PES 800 (Danquinsa GmbH, Dettenhausen, Germany), Tego Addbond LTH (Evonik Industries AG, Essen, Germany), Vitel 3300B (Bostik GmbH, Borgholzhausen, Germany).

Further, it is preferred that the at least one adhesive layer of the at least one decorative ply and/or the at least one adhesive layer of the at least one protective ply has a non-volatile proportion in the range of from 5 wt.-% to 70 wt.-%, preferably 10 wt.-% to 50 wt.-% (wt.-%=percent by weight), in particular in each case relative to the total weight of all constituents of the respective at least one adhesive layer, preferably directly after being deposited.

It is also preferred that the at least one adhesive layer of the at least one decorative ply and/or the at least one adhesive layer of the at least one protective ply has a thickness in the range of from 1 μm to 20 μm, in particular of from 2 μm to 7 μm.

It possible in particular for the at least one adhesive layer of the at least one decorative ply and/or the at least one adhesive layer of the at least one protective ply to have a softening range in a range of between 40° C. and 180° C., further preferably between 60° C. and 140° C.

Here, a sufficient softening and adaptation to the surrounding surfaces of the adhesive layer during the lamination and thus a good and complete adhesion of the decorative ply and/or protective ply are preferably guaranteed.

It is also preferably provided that the at least one adhesive layer of the at least one decorative ply and/or the at least one adhesive layer of the at least one protective ply is formed transparent or translucent or opaque and/or dyed or at least partially dyed and/or crystal clear.

Preferable embodiments of the at least one protective ply, comprising at least one protective layer and at least one adhesive layer, are described in the following:

The at least one protective ply covers the at least one decorative ply at least partially, in particular over the whole surface. The at least one protective ply preferably forms the visible side of the multilayer body. This means that the at least one protective ply forms the top ply and the substrate preferably forms the bottom ply in a top view, thus when looked at perpendicular to the surface of the plane spanned by the substrate. In other words, it is preferred that the at least one protective ply is attached to the side of the at least one decorative ply facing away from the substrate.

In particular, the at least one protective ply here protects the at least one decorative ply from chemical, physical and/or mechanical environmental influences.

It is preferred that the at least one protective ply is applied register-accurately to the decorative ply.

It is provided that the at least one protective layer has a grammage in the range of from 5 g/m₂ to 300 g/m₂, preferably in the range of from 20 g/m₂ to 100 g/m₂.

It is possible for the at least one protective layer to be dyed, in particular for the at least one protective layer to be dyed by means of dyes and/or pigments, wherein the pigmentation level of the at least one protective layer is preferably less than 20%, preferably less than 15%, further preferably less than 10%.

Alternatively, it is also possible for the at least one protective layer not to be dyed and/or the pigmentation level of the at least one protective layer to be less than 5%.

It is preferred in particular that the transmittance of the at least one protective layer is 0.5, preferably 0.7, in particular in the case of a measurement according to DIN EN ISO 13468-1:2019-10 (“Plastics—Determination of the total luminous transmittance of transparent materials—Part 1: Single-beam instrument”, issue date: 2019-10) with an illuminant D65, preferably with compensation, has.

In other words, it is provided in particular that at least 50%, preferably at least 70%, of the light incident and/or irradiated on the at least one protective layer is perceived on the opposite side, in particular in the case of a measurement according to DIN EN ISO 13468-1:2019-10 with an illuminant D65, preferably with compensation.

By compensation is preferably meant the minimization of in particular extraneous light, aging and/or temperature drift phenomena.

In particular, the quantity of light allowed to pass through consists of a directed and an undirected, thus diffuse, component. Depending on the angular distribution of the diffuse component, a transparent material preferably exhibits different effects. Here, a distinction is preferably drawn between wide- and small-angle scattering.

Further, it is preferably provided that the at least one protective layer has a haze value of at most 100%, preferably at most 90%, in particular in the case of a measurement according to DIN EN ISO 13468-1:2019-10 with an illuminant D65, preferably with compensation.

In other words, it is provided in particular that the at least one protective layer diffusely scatters transmitted light, preferably of the illuminant D65, preferably with compensation, further preferably according to DIN EN ISO 13468-1:2019-10, and/or in particular deflects it by less than 20%, preferably by less than 10%, by scattering.

It is also possible for the at least one protective layer to have an image sharpness value of from 0.5% to 10%, preferably of from 1% to 5%, in particular in the case of a measurement according to DIN EN ISO 13468-1:2019-10 with an illuminant D65, preferably with compensation.

By haze or cloudiness is preferably meant here a diffuse scattering, in particular wide-angle scattering, which in particular results in a decrease in the imaging quality.

Particles or inhomogeneities in the material, at which in particular the light is scattered in all spatial directions, preferably act as scattering centers, wherein advantageously only a low scattering intensity falls on each solid angle. In particular, a reduction in the contrast and/or a milky-cloudy appearance is hereby brought about, wherein this effect is preferably called haze or cloudiness. Thus, the haze value preferably represents a measure of the cloudiness of transparent samples, for example of layers, plies and/or films.

By clarity or image sharpness is preferably meant here a diffuse scattering, in particular small-angle scattering, which in particular results in a decrease in the imaging quality. Here, the light is deflected within a small solid angle, preferably less than 2.5°, in such a way that the quantity of scattered light is concentrated in a narrow lobe. As a result of this, in particular, contours become distorted and/or appear less sharp, wherein this effect is preferably called clarity or image sharpness. Thus, the clarity value preferably represents a measure of the image sharpness of transparent samples, for example of layers, plies and/or films.

The haze value and the clarity value are preferably determined according to DIN EN ISO 13468-1:2019-10. For example, the haze value and the clarity value are measured with the “BYK haze-gard i” measurement device from Byk-Gardener GmbH, Geretsried, Germany. Here, the layer, ply or film to be measured is preferably held in the open sample compartment of the measurement device, and in particular for the haze value is placed against the so-called “haze port” of the device, wherein the measurement is advantageously carried out by means of illuminant D65, preferably with compensation. The result of the measurement is then preferably displayed on the measurement device's screen. Since the haze value and the clarity value are advantageously indicated in percent (%), the value ranges of the haze value and of the clarity value are therefore preferably 0% to 100%. The maximum value is preferably 100%. Values higher than 100% possibly occurring can be caused for example, in particular depending on the measurement principle used, by additional scattered light effects and/or reflection effects during the measurement.

By an illuminant D65 is preferably meant a standard light with particular spectral properties which have been defined by the Commission Internationale d'Eclairage (CIE). The standard illuminant D preferably comprises the daylight spectrum, wherein the illuminant D65 preferably has a color temperature of 6504 K. The spectral distribution of D65 light sources is defined in particular in DIN 5033 and comprises wavelengths in a range of from 300 nm to 780 nm. The substrate surface is further preferably illuminated with a luminous intensity of 2000 Lux.

Through the above-described advantageous embodiments, the at least one protective layer is preferably not directly perceptible for the observer, but instead interesting optical effects are brought about hereby. The at least one decorative ply lying underneath further preferably obtains the preferred matteness and/or soft focus.

Further, the at least one protective layer is preferably only perceptible because the at least one decorative ply lying behind it has a matte and less brilliant effect because of the cloudiness due to the at least one protective layer. In particular, the at least one decorative ply is thereby provided with a soft-focus effect to some extent, whereby surface areas with reduced contrast form.

For example, a transparent paper, in particular from the manufacturer Canson, with a grammage in the range of from 40 g/m₂ to 45 g/m₂ thus has a transmittance of between 83% and 85%, a haze value of 100% and an image sharpness value of from 1.70% to 1.85%. A transparent paper, in particular from the manufacturer Canson, again for example with a grammage of 70 g/m₂ has a transmittance of from 80% to 82%, a haze value of 100% and an image sharpness value of from 1.45% to 1.5%.

A printer paper used for comparison, in particular from the manufacturer Steinbeis, with a degree of whiteness of 90 according to ISO 11475:2017 (“Paper and board—determination of CIE whiteness D65/10 degrees (outdoor daylight)”, issue date: 2017-05) and a grammage of 70 g/m₂ has for example a transmittance of 15.5%, a haze value of 103% and an image sharpness value of 0.67%.

In particular in the case of the transparent papers from Canson, a decorative ply lying underneath is still visible and preferably provided with a soft-focus effect, while in particular the printer paper from Steinbeis is not transparent and the decorative ply is completely concealed from the observer.

It is also possible for the at least one protective ply to have several protective layers, wherein these preferably differ in terms of their properties, preferably optical properties. For example, the several protective layers differ by the pigmentation level and/or type of pigments and/or transmittance and/or color and/or cloudiness and/or image sharpness and/or thickness.

Further, it is also possible for the multilayer body to have at least two, in particular differing, protective plies, which preferably differ by pigmentation level and/or type of pigments and/or transmittance and/or color and/or cloudiness and/or image sharpness and/or thickness. The at least two protective plies preferably have in each case at least one protective layer and one adhesive layer, wherein the at least one protective layer comprises or consists of paper, in particular transparent paper. Further, the at least two protective plies are preferably designed according to the embodiments of the at least one protective ply.

In particular, it is possible for at least two, in particular differing, protective plies, which preferably viewed in a top view, to be present next to each other. It is also possible for at least two, in particular differing, decorative plies, which preferably viewed in a top view, to be present at least partially one over another and/or overlapping.

In a preferred embodiment, it is possible for the at least one decorative ply to be present in a first area and not to be present in a second area. In this embodiment, plies and/or layers of the multilayer body, in particular the substrate, are recognizable for the observer preferably in the first area and their optical properties can also contribute to the overall impression.

In a further embodiment, it is expedient that the at least one protective ply is present in a third area and not present in a fourth area, wherein here the at least one decorative ply is exposed in the fourth area. In this design variant, the at least one decorative layer is thus not covered with the at least one protective ply in the fourth area. This is advantageous in particular if, for example for optical reasons, the decorative ply is to be perceived uninfluenced in particular areas (here the fourth area) and/or a particularly high gloss or a brilliance is desired.

In one design, it is preferably provided that the substrate is present in a fifth area and not present in a sixth area. In particular, in the case of a decoration with at least one decorative ply which is designed at least partially transparent, see-through areas can be created here in a top view.

In particular, it is possible for the first, second, third, fourth, fifth and/or sixth areas, in particular viewed in a top view, thus at a viewing angle perpendicular to the plane spanned by the substrate, decorative ply and/or protective ply, to overlap partially or completely.

Further, it is possible for the first area to overlap with the third area and the second area to overlap with the fourth area. In other words, it is possible for the at least one decorative ply, for example a metal layer, and the at least one protective ply to overlap at least partially, preferably over the whole surface, wherein the substrate is at least partially not covered by the at least one protective ply and the at least one decorative ply. Here, for example, the optical properties of the substrate are recognizable for the observer in the second or fourth area without being influenced by other plies.

Furthermore, it is possible to apply the multilayer body according to the invention to a further substrate through a further laminating process or bonding process. For example, the further substrate is made of card, preferably packaging card. The total thickness of a thus-produced multilayer body laminate preferably lies in a range of from 1 mm to 5 mm, preferably 1 mm to 3 mm.

This makes it possible to produce particularly high-quality packaging with more complex decoration, the optical appearance of which can be individually adapted to the use.

The adhesion of the layers of the multilayer body, in particular its resistance to mechanical influences, is an important property with respect to its usability.

The adhesion of the multilayer body can preferably be determined with a cross-cut test according to DIN EN ISO 2409:2013-06 (“Beschichtungsstoffe—Gitterschnittprūfung [Paints and varnishes—Cross-cut test] (ISO 2409:2013), German version of EN ISO 2409:2013”, issue date: 2013-06).

The evaluation is effected in particular in accordance with DIN EN ISO 2409:2013-06 by visual assessment of the measurement area and classification into cross-cut characteristic values of from 0 (very good adhesion) to 5 (very poor adhesion), abbreviated to GT 0 to GT 5.

Further, an evaluation of the surface in accordance with ASTM D3359-09 (“Standard Test Methods for Measuring Adhesion by Tape Test”, issue date: 2009), test method B, is also possible, wherein the characteristic values are classified from 0B (very good adhesion) to 5B (very poor adhesion).

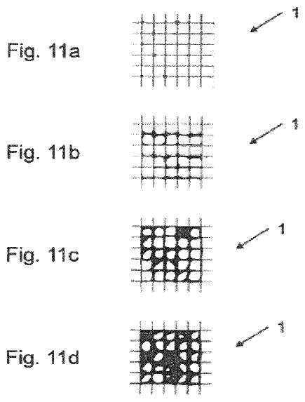

The preferred criteria for a classification of the corresponding characteristic values are summarized in Table 1 and in FIGS. 11a to 11d.

In the case of multilayer bodies according to the invention, cross-cut characteristic values of GT 0 and/or 5B preferably result.

TABLE 1
Criteria for a classification of the cross-cut
adhesion in characteristic values,
in particular according to DIN EN
ISO 2409:2013-06 and ASTM D3359-09

| | | Character- | Character - |
|---|---|---|---|
| | | istic | istic |
| | | value | value |
| Description | Surface | ISO | ASTM |
| The edges of the cuts are | — | GT0 | 5 B |
| completely smooth, no section of | | | |
| the coating has flaked. | | | |
| Small flakes of the coating have | FIG. 11a | GT 1 | 4 B |
| detached at the intersections of the | | | |
| cut lines; flaked area | | | |
| approximately 5% of the sections. | | | |
| The coating has flaked along the | FIG. 11b | GT 2 | 3 B |
| edges of the cuts and/or at the | | | |
| intersections of the cut lines; | | | |
| flaked area approximately 15% | | | |
| of the sections. | | | |
| The coating has flaked partially or | FIG. 11c | GT 3 | 2 B |
| completely in broad strips along | | | |
| the edges of the cuts and/or the | | | |
| coating has flaked completely or | | | |
| partially on individual sections; | | | |
| flaked area approximately 35% of | | | |
| the sections. | | | |
| The coating has flaked in broad | FIG. 11d | GT 4 | 1 B |
| strips along the edges of the cuts | | | |
| and/or completely or partially on | | | |
| individual sections; flaked area | | | |
| approximately 65% of the sections. | | | |
| Flaked area more than 65% of the | — | GT 5 | 0 B |
| sections. | | | |

The gloss of the surface is a further property of the multilayer body which influences its optical appearance and thus also its preferred application.

By gloss is preferably meant the optical property of a surface to reflect light. In order to make the gloss of surfaces technically comparable, the gloss value in gloss units [GU] is preferably determined by means of a glossmeter or reflectometer. For example, for a determination of the gloss value is carried out with a model ZGM 1130 reflectometer (Zehntner GmbH, Sissach, Switzerland).

In particular, measurements of the gloss value of decorative plies, in particular metal layers, were carried out on the example of stamped Aluf in MTS (LEONHARD KURZ Stiftung & Co. KG, Fürth, Germany), MTS 220 (LEONHARD KURZ Stiftung & Co. KG, Fürth, Germany) and Colorit V red (LEONHARD KURZ Stiftung & Co. KG, Fürth, Germany) at the measurement angles 20°, 60° and 85°, which are preferably formed between the plane spanned by the decorative ply and the incident light beam. The results are represented in Table 2. Here, in each case once, the surface of the decorative ply stamped only onto a substrate (variant V1) and in each case the surface of the decorative ply, stamped onto a substrate, to which a protective ply has been applied over the whole surface (variant V2) were measured. Further, the paper base layer (card) GC 1 used as substrate was measured. A transparent paper (TPL) was used as protective ply.

TABLE 2
Gloss values in [GU] of the measured surfaces at three different
measurement angles, wherein no protective ply was applied in
variant V1 and a protective ply was applied in variant V2.

| | Angle | | |
|---|---|---|---|
| Measured surface | 20° | 60° | 85° |
| MTS 220 (V1) in [GU] | 741 | 645 | 116 |
| MTS 220 (V2) in [GU] | 3.4 | 6.6 | 5.3 |
| Alufin MTS (V1) in [GU] | 761 | 743 | 117 |
| Alufin MTS (V2) in [GU] | 4.6 | 7.6 | 6.2 |
| Colorit V red (V1) in [GU] | 3.8 | 29.4 | 64.9 |
| Colorit V red (V2) in [GU] | 0.4 | 2.4 | 4.3 |
| Card GC 1 in [GU] | 1.5 | 11.8 | 63 |

It was surprisingly established that when a high-gloss decorative ply is used, which thus has a gloss value of 100 GU or more, further preferably of 250 GU or more, in particular at a measurement angle of 60°, under light, in particular light in the wavelength range of between 300 nm and 780 nm, and when a transparent paper is laminated over it a particularly decorative added value preferably arises.

This is true for example in the case of the use of metallically glossy decorative plies, in particular Aluf in MTS or MTS 220. This particular decorative added value is not apparent in the case of non-glossy decorative plies, for example Colorit V red.

In other words, no gloss, in particular metallic gloss in the case of metallically glossy decorative plies, is visible in the case of decorative plies with a gloss value of less than 100 GU, preferably at a measurement angle of 60° and in particular under light in the wavelength range of between 300 nm and 780 nm, after a protective ply, in particular made of transparent paper, has been laminated over it.

In comparison, a flop effect preferably arises in the case of decorative plies with a gloss value of 100 GU or more when viewed from different angle ranges.

By flop effect is preferably meant a lightness flop. In other words, by this is preferably meant a change in the lightness when the measurement angle is changed.

Further preferably, a decorative ply with a protective ply, preferably comprising transparent paper, laminated over it exhibits different effects at different measurement angles. These effects preferably occur under diffuse light, thus under a uniform and low-contrast and low-shadow illumination, in particular by extensive light sources or diffusers.

When the surface of the decorative ply is viewed at an angle in the range comprising 45° and 135°, in particular a metallically glossy decorative ply preferably appears semi-matte, thus with subtle reflection. Preferably, the surface, in particular when viewed at an angle in the range of from smaller than 45° to 0° and/or when viewed at an angle of from greater than 135° to 180°, further appears preferably iridescent and with the look and feel of white paper.

Surprisingly, it has further been established that, in particular when a transparent paper with a grammage in the range of from 40 g/m₂ to 45 g/m₂ is laminated over a watermark, the effect of a watermark is practically no longer apparent for the naked eye of an observer.

The multilayer body according to the invention is preferably used for posters, placards, decorative material, labels, packaging material, in particular packaging card, outer packaging, wrapping paper, book covers and/or envelopes.

It is preferably provided that step a) further comprises the following steps, which are in particular carried out in the following order:
a1) preparing the substrate,
a2) preparing the at least one decorative ply as a transfer ply of a transfer film, wherein the transfer film further comprises a carrier ply and the transfer ply,
a3) applying the at least one decorative ply to the substrate in at least one partial area,
a4) peeling off the carrier ply, in particular to obtain the substrate provided with the at least one decorative ply.

It is further preferred that the substrate provided with the at least one decorative ply in step a4) corresponds to the substrate prepared in step a).

In particular, it is preferred that the substrate prepared in step a), further preferably in step a1), comprises at least one optical coat.

It is also preferred that the at least one decorative ply applied to the substrate in step a), in particular the at least one decorative ply prepared in step a2), has at least one protective varnish layer and/or at least one decorative layer and/or a functional layer and/or at least one primer layer and/or at least one adhesive layer and/or at least one color layer.

In particular, it is preferred that the application of the at least one decorative ply to the substrate in at least one partial area according to step a3) and/or the application of the at least one protective ply to the substrate provided with at least one decorative ply according to step c) is effected by means of one of the following methods: stamping, in particular hot stamping or cold stamping, or printing, in particular intaglio printing and/or screen printing and/or offset printing and/or inkjet printing and/or xerographic printing (laser print), or lamination, in particular hot lamination.

The application of the at least one protective ply to the substrate provided with the at least one decorative ply according to step c) is further preferably effected with at least one of the following parameters, in particular with the following parameters: speed: 1 m/min to 20 m/min, in particular 2 m/min to 10 m/min, roller temperature: 60° C. to 180° C., in particular 80° C. to 140° C., roller pressure: 1 bar to 20 bar.

Further, it is preferred that the transfer film prepared in step a2) has at least one detachment layer, which is in particular arranged between the carrier ply and the transfer ply.

It is also preferred that the at least one detachment layer comprises a material or a combination of materials which is selected from the group waxes, silicones, polyurethanes and/or polymers, preferably acrylate copolymer, polyester copolymers, polystyrene copolymers, polycarbonate copolymers.

It is preferred that the at least one detachment layer has a thickness in the range of from 0.01 μm to 0.50 μm.

In particular, it is preferred that the at least one detachment layer is formed transparent or translucent or opaque and/or dyed or at least partially dyed and/or crystal clear.

In a preferred embodiment, it is possible for the at least one decorative ply to be applied in a first area and not to be applied in a second area.

In a further embodiment, it is expedient that the at least one protective ply is applied in a third area and is not applied in a fourth area.

In one design, it is preferably provided that the substrate is applied in a fifth area and is not applied in a sixth area.

In particular, it is possible for the first and/or second and/or third and/or fourth and/or fifth and/or sixth areas, in particular viewed in a top view, thus at a viewing angle perpendicular to the plane spanned by the substrate, decorative ply and/or protective ply, to overlap partially or completely.

Of course, the above-mentioned characteristics can also be applied in an equivalent way in the method.

In the following, the invention is explained by way of example with reference to several embodiment examples utilizing the attached schematic drawings. The embodiment examples shown are therefore not to be understood as limitative.

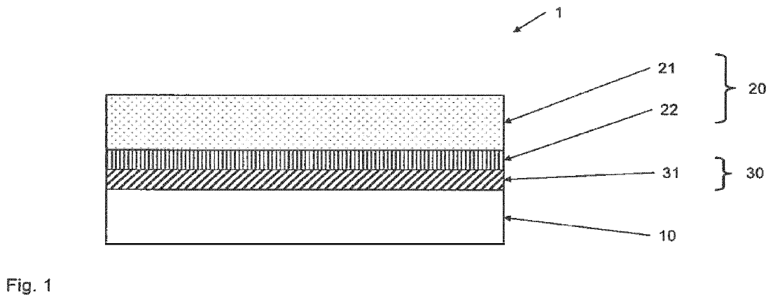

FIG. 1 shows a sectional representation of a multilayer body.

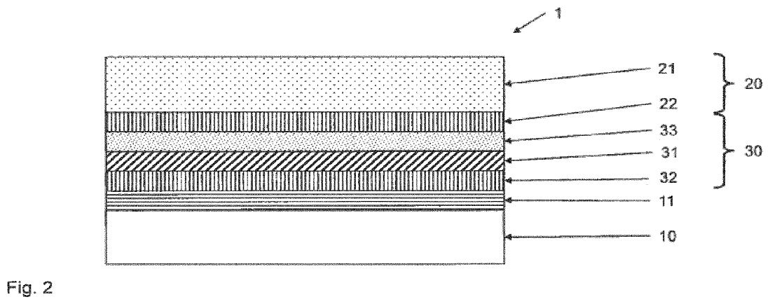

FIG. 2 shows a further sectional representation of a multilayer body.

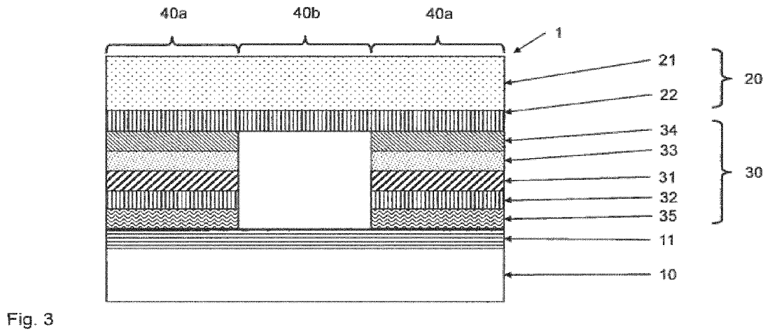

FIG. 3 shows a further sectional representation of a multilayer body.

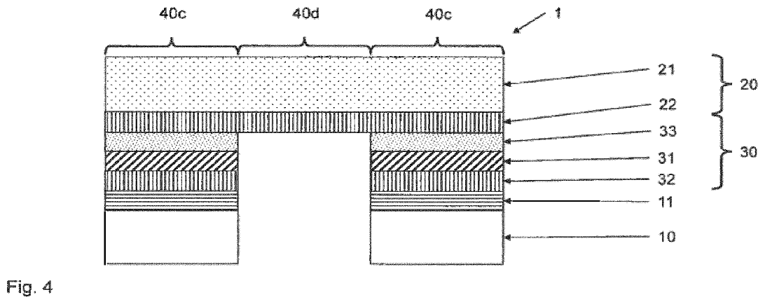

FIG. 4 shows a further sectional representation of a multilayer body.

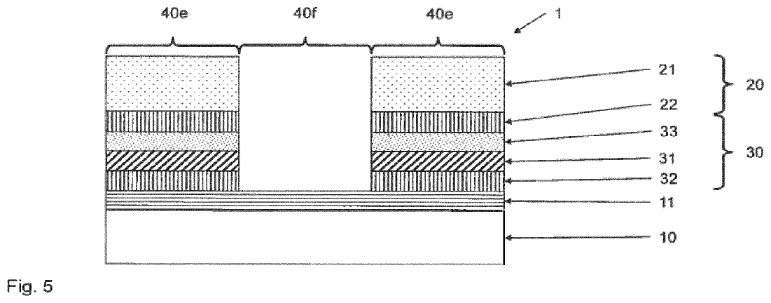

FIG. 5 shows a further sectional representation of a multilayer body.

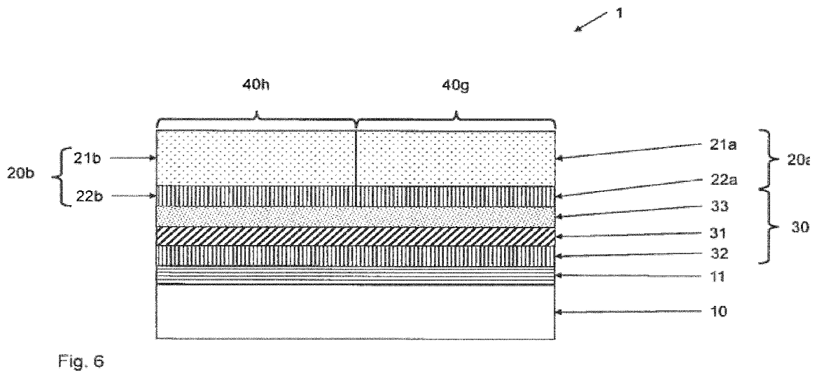

FIG. 6 shows a further sectional representation of a multilayer body.

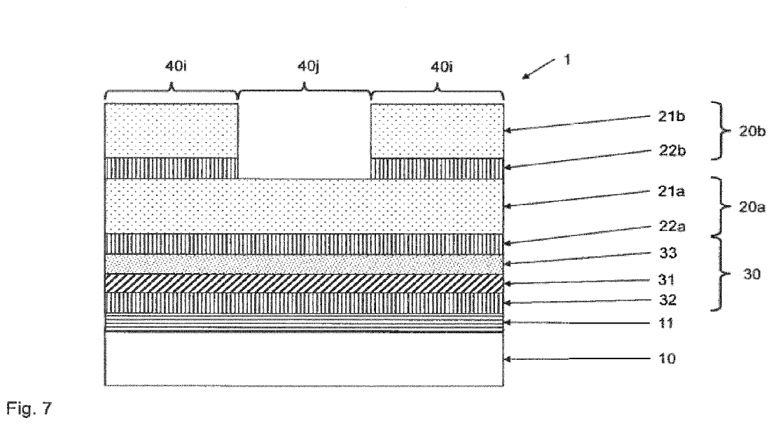

FIG. 7 shows a further sectional representation of a multilayer body.

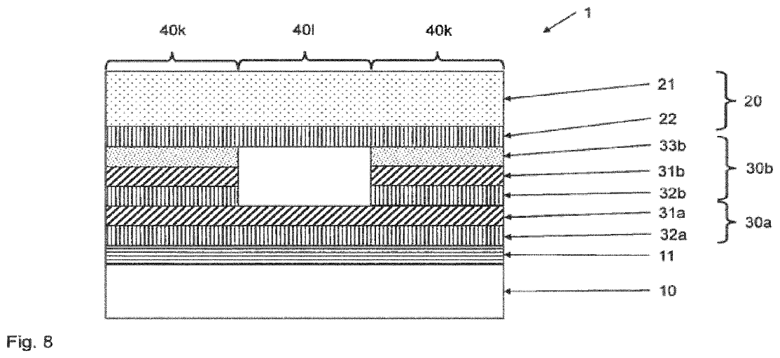

FIG. 8 shows a further sectional representation of a multilayer body.

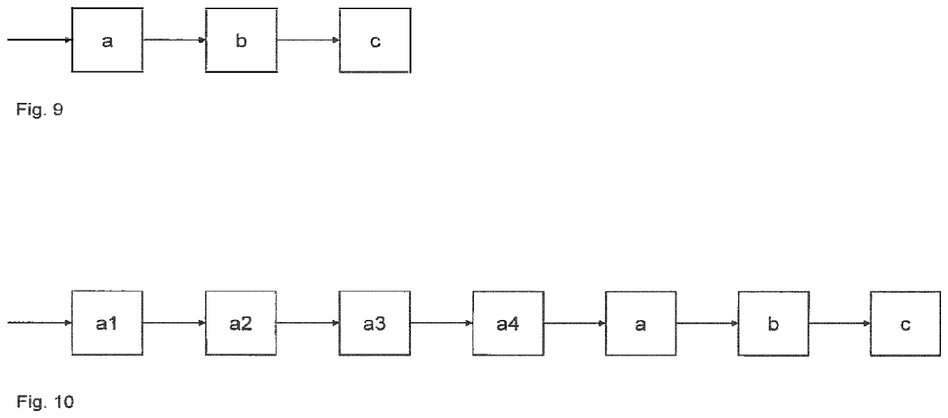

FIG. 9 shows a representation of a method for producing a multilayer body.

FIG. 10 shows a further representation of a method for producing a multilayer body.

FIGS. 11a to 11d show results of a cross-cut test for a classification of the cross-cut adhesion into characteristic values.

FIG. 1 shows a sectional representation of a multilayer body 1, in particular a laminate, preferably comprising a substrate 10, at least one decorative ply 30 and at least one protective ply 20. As shown in FIG. 1, the at least one protective ply 20 comprises at least one adhesive layer 22 and at least one protective layer 21, wherein the at least one protective layer 21 comprises or consists of paper, in particular transparent paper.

The production of the multilayer body shown in FIG. 1 is preferably effected according to the method shown in FIG. 9, wherein this comprises the following steps, which are in particular carried out in the following order:
a) preparing a substrate 10 provided with at least one decorative ply 30,
b) preparing at least one protective ply 20, wherein the protective ply 20 comprises at least one protective layer 21 and at least one adhesive layer 22, wherein the at least one protective layer 21 comprises or consists of paper, in particular transparent paper,
c) applying the at least one protective ply 20 to the substrate 10 provided with the at least one decorative ply 30, in particular to obtain the multilayer body 1.

The substrate 10 preferably comprises a material which is selected from the group which consists of paper, card, cardboard, preferably paper, card, and further preferably coated graphic paper, uncoated graphic paper, coated paper for packaging, uncoated paper for packaging, coated card, uncoated card, and mixtures thereof.

In particular, it is advantageous if the substrate 10 is formed translucent or opaque and/or dyed or at least partially dyed.

The substrate 10 preferably has a grammage in the range of from 50 g/m₂ to 500 g/m₂.

The substrate 10 preferably has a surface smoothness in the range of from 0.5 μm to 8.0 μm, preferably in the range of from 1.0 μm to 3.0 μm, in particular measured using the Parker Print-Surf (PPS) method according to DIN ISO 8791-4:2008-05 (“Paper and board—Determination of roughness/smoothness (air leak methods)—Part 4: Print-surf method”, issue date: 2008-05), and/or a surface smoothness in the range of from 50 ml/min to 900 ml/min, preferably in the range of from 100 ml/min to 400 ml/min, in particular measured using the Bendtsen method according to DIN ISO 8791-2:2013-09 (“Paper and board—Determination of roughness/smoothness (air leak methods) Part 2: Bendtsen method”, issue date: 2013-09).

In this preferred embodiment, the at least one decorative ply 30 is preferably attached between the substrate 10 and the at least one protective ply 20.

As shown in FIG. 1, the decorative ply 30 has a decorative layer 31. In an alternative variant, not shown in FIG. 1, the decorative ply 30 has at least one protective varnish layer 33 and/or at least one decorative layer 31 and/or a functional layer and/or at least one primer layer 35 and/or at least one adhesive layer 32 and/or at least one color layer 34.

It is provided in particular that the decorative ply 30 has a thickness in the range of from 1.0 μm to 5 μm, in particular of from 1.0 μm to 2 μm.

It is provided in particular that the at least one decorative layer 31 of the at least one decorative ply 30 comprises at least one metallic layer and/or at least one dielectric layer.

The at least one decorative layer 31 preferably has a thickness in the range of from 8 nm to 1000 nm, preferably of from 8 nm to 200 nm, in particular preferably of from 10 nm to 100 nm.

It is provided in particular that the at least one metallic layer comprises a material or a combination of materials selected from: aluminum, silver, gold, copper, nickel, chromium, indium, tin and/or an alloy comprising at least two of these metals.

The at least one dielectric layer preferably comprises a material or a combination of materials selected from: metal oxide, polymer, varnish, HRI material, in particular MgO, TiOₙ, Al₂O₃, ZnO, ZnS and/or SiOₙ, wherein n preferably comprises the range of from 1 to 3.

It is provided in particular that the at least one decorative layer 31 is formed of an HRI material, preferably CdSe, CeTe, Ge, HfO₂, PbTe, Si, Te, TiCl or ZnTe, which is in particular radiolucent at least for partial ranges of the spectrum in the UV range, in particular for the wavelength range of from 250 nm to 400 nm.

In particular, it is further possible for the at least one decorative layer 31 to have at least one layer generating an optically variable effect.

It is provided in particular that the at least one decorative layer 31 has at least one replication varnish layer with a surface structure molded into the at least one replication varnish layer, in particular wherein the surface structure molded into the at least one replication varnish layer is selected from: diffractive surface structure, refractive surface structure, lens structure, matte structure, blazed grating.

It has proved worthwhile if the at least one decorative layer 31 has a diffractive and/or refractive relief structure for generating optically variable effects and/or a macrostructure for generating three-dimensional effects or depth effects. Through diffractive and/or refractive relief structures, which are formed in particular in a transparent varnish layer or replication varnish layer, different optical effects, so-called optically variable effects, can be achieved depending on the viewing angle, such as holograms, three-dimensional representations with kinematic effect dependent on the viewing angle, etc.

In order in particular to improve the visibility of relief structures, these are usually arranged adjoining a strongly reflective metallic layer and/or dielectric HRI layer with a comparatively high to very high refractive index, in particular consisting of a metal oxide. Such a highly reflective layer is preferably formed over the whole surface or patterned.

Furthermore, it is also preferably provided that the at least one decorative layer 31 is designed with optically variable pigments, luminescent substances, magnetic or electrically conductive substances, a color layer, a thin-film stack with interference color effect dependent on the viewing angle, a liquid-crystal layer, or also a combination of above-named layers comprising metallic layers, dielectric layers etc.

The at least one decorative layer 31 preferably has at least one reflective layer, preferably designed patterned.

In particular, the at least one decorative layer 31 has at least one thin-film layer element for generating a color shift effect dependent on the viewing angle.

Furthermore, it is preferred that the at least one decorative layer 31 has a gloss value of 100 GU or more, further preferably of 250 GU or more, in particular at a measurement angle of 60°, under light, in particular light in the wavelength range of between 300 nm and 780 nm.

It is provided in particular that the at least one adhesive layer 22 of the at least one protective ply 20 covers the at least one decorative ply 30 at least partially or over the whole surface.

It is provided in particular that the at least one adhesive layer 22 of the at least one protective ply 20 comprises several adhesive layers which are different in terms of their chemical and/or physical properties.

It is preferably also possible for the at least one adhesive layer 22 of the at least one protective ply 20 to be formed of a hot glue and/or a thermoplastic adhesive and/or a cold glue and/or a radiation-curable adhesive, in particular an adhesive that can be cured by means of electromagnetic radiation and/or electron beam radiation and/or by means of UV radiation, and/or an oxidatively curing adhesive and/or a low-migration adhesive.

It is also preferred that the at least one adhesive layer 22 of the at least one protective ply 20 comprises or consists of polyester resins. For example, the protective ply 20 comprises one of the following polyester resins and/or combinations thereof: Danpol PES 800 (Danquinsa GmbH, Dettenhausen, Germany), Tego Addbond LTH (Evonik Industries AG, Essen, Germany), Vitel 3300B (Bostik GmbH, Borgholzhausen, Germany).

Further, it is preferred that the at least one adhesive layer 22 of the at least one protective ply 20 has a non-volatile proportion in the range of from 5 wt.-% to 70 wt.-%, preferably 10 wt.-% to 50 wt.-%, in particular in each case relative to the total weight of all constituents of the respective at least one adhesive layer, preferably directly after being deposited.

It is also preferred that the at least one adhesive layer 22 of the at least one protective ply 20 has a thickness in the range of from 1 μm to 20 μm, in particular of from 2 μm to 7 μm.

It possible in particular for the at least one adhesive layer 22 of the at least one protective ply 20 to have a softening range in a range of between 40° C. and 180° C., further preferably between 60° C. and 140° C.

It is also preferably provided that the at least one adhesive layer 22 of the at least one protective ply 20 is formed transparent or translucent or opaque and/or dyed or at least partially dyed and/or crystal clear.

The at least one protective ply 20 covers the at least one decorative ply 30 at least partially, in particular over the whole surface. The at least one protective ply 20 preferably forms the visible side of the multilayer body 1. This means that the at least one protective ply 20 forms the top ply in a top view. In other words, it is preferred that the at least one protective ply 20 is attached to the side of the at least one decorative ply 30 facing away from the substrate 11.

In the case of the multilayer body 1 shown in FIG. 1, the protective ply 20 covers the decorative ply 30 over the whole surface and further also forms the visible side of the multilayer body 1.

In particular, the at least one protective ply 20 here protects the at least one decorative ply 30 from chemical, physical and/or mechanical environmental influences.

It is preferred that the at least one protective ply 20 is applied register-accurately to the decorative ply 30.

It is provided that the at least one protective layer 21 has a grammage in the range of from 5 g/m₂ to 300 g/m₂, preferably in the range of from 20 g/m₂ to 100 g/m₂.

It is possible for the at least one protective layer 21 to be dyed, in particular for the at least one protective layer 21 to be dyed by means of dyes and/or pigments, wherein the pigmentation level of the at least one protective layer 21 is preferably less than 20%, preferably less than 15%, further preferably less than 10%.

Alternatively, it is also possible for the at least one protective layer 21 not to be dyed and/or the pigmentation level of the at least one protective layer 21 to be less than 5%.

It is preferred in particular that the ratio of the quantity of the light allowed to pass through by the protective layer 21 to the quantity of the incident light is at least 0.5, preferably 0.7, in particular in the case of a measurement according to DIN EN ISO 13468-1:2019-10 with an illuminant D65, preferably with compensation, has.

In other words, it is provided in particular that the at least one protective layer 21 has a transmittance of at least 50%, preferably at least 70%, in particular in the case of a measurement according to DIN EN ISO 13468-1:2019-10 with an illuminant D65, preferably with compensation.

Further, it is preferably provided that the at least one protective layer 21 has a haze value of at most 100%, preferably at most 90%, in particular in the case of a measurement according to DIN EN ISO 13468-1:2019-10 with an illuminant D65, preferably with compensation.

In other words, it is provided in particular that the at least one protective layer 21 diffusely scatters transmitted light, preferably of the illuminant D65, preferably with compensation, further preferably according to DIN EN ISO 13468-1:2019-10, and/or in particular deflects it by less than 20%, preferably by less than 10%, by scattering.

It is also possible for the at least one protective layer 21 to have an image sharpness value of from 0.5% to 10%, preferably of from 1% to 5%, in particular in the case of a measurement according to DIN EN ISO 13468-1:2019-10 with an illuminant D65, preferably with compensation.

For example, the substrate 10, as described in step a), can be a prepared approx. 20 cm×30 cm large piece of a sheet of paper, from Sappi (type: Magno Gloss Arctic White, 200 g/m₂). The substrate 10 is decorated, using a flat stamp (brass stamp from Hinderer & Mühlich, dimensions 7 cm×10 cm) in a manual stamping machine (Gierlich P5000, temperature at the stamp 119° C.), with a decorative ply 30, for example a golden hot-stamping film (LUXOR MTS 220) as decorative layer 31.

According to step b), a protective ply 20 is further provided, which can for example comprise a transparent paper from Canson with a grammage in the range of from 40 g/m₂ to 45 g/m₂ as protective layer 21. A solvent-containing adhesive layer 22 made of for example Tego Addbond LTH, Vitel 3300B and Danpol PES 800 in methyl ethyl ketone is applied to the protective layer 21. The adhesive layer 22 here has in particular a non-volatile proportion of approx. 25 wt.-% with an application weight of 5 g/m₂. The adhesive layer 22 is dried to constant weight under standard atmospheric conditions and preferably forms a closed layer on the transparent paper.

The protective ply 20, comprising the transparent paper coated with an adhesive layer 22, is then laminated to the substrate decorated with the stamping film, preferably over the whole surface, in a laminating method corresponding to step c). The coated transparent paper is then laid, with the adhesive layer 22, on the decorated substrate, with the result that the decorated surface area is covered, preferably completely, by the transparent paper with an overhang of in particular 3 cm on each side.

The lamination, preferably over the whole surface, of the transparent paper coated with an adhesive layer 22 to the substrate 10 provided with a decorative ply 30 is effected for example in the roll-off method with at least one of the following parameters, in particular with the following parameters:

speed: 1 m/min to 20 m/min, in particular 2 m/min to 10 m/min,
roller temperature: 60° C. to 180° C., in particular 80° C. to 140° C.,
roller pressure: 1 bar to 20 bar.

The multilayer body 1 shown in FIG. 1 is preferably used for posters, placards, decorative material, labels, packaging material, in particular packaging card, outer packaging, wrapping paper, book covers and/or envelopes.

FIG. 2 shows a sectional representation of a multilayer body 1 with the same structure as the multilayer body 1 according to FIG. 1, which has a substrate 10, at least one decorative ply 30 and at least one protective ply 20. Here, the decorative ply 30 further comprises for example, in addition to at least one decorative layer 31, at least one protective varnish layer 33 and at least one adhesive layer 32. The substrate 10 here comprises at least one optical coat 11.

In the case of the multilayer body 1 shown in FIG. 2, the at least one decorative ply is covered over the whole surface by the at least one protective ply 20. The protective ply furthermore also forms the visible side of the multilayer body 1.

The production of the multilayer body 1 according to FIG. 2 is preferably effected according to a method like the production of the multilayer body 1 according to FIG. 1, wherein the method as shown in FIG. 10 in particular has further steps.

In particular, step a) of the method shown in FIG. 10 further comprises the following steps, which are in particular carried out in the following order:
a1) preparing the substrate 10,
a2) preparing the at least one decorative ply 30 as a transfer ply of a transfer film, wherein the transfer film further comprises a carrier ply and the transfer ply,
a3) applying the at least one decorative ply 30 to the substrate 10 in at least one partial area,
a4) peeling off the carrier ply, in particular to obtain the substrate 10 provided with the at least one decorative ply 30.

It is further preferred that the substrate 10 provided with the at least one decorative ply 30 in step a4) corresponds to the substrate 10 prepared in step a).

In particular, it is preferred that the application of the at least one decorative ply 30 to the substrate 10 in at least one partial area according to step a3) and/or the application of the at least one protective ply to the substrate 10 provided with the at least one decorative ply 30 according to step c) is effected by means of one of the following methods: stamping, in particular hot stamping or cold stamping, or printing, in particular intaglio printing and/or screen printing and/or offset printing and/or inkjet printing and/or xerographic printing (laser print), or lamination, in particular hot lamination.

It is preferred that the at least one optical coat 11 is attached at least to the substrate side which faces the at least one decorative ply 30. Still further preferably, a further optical coat 11 is also attached to the substrate side which faces away from the at least one decorative ply 30.

The at least one optical coat 11 is preferably dyed, in particular by means of dyes and/or pigments, wherein the pigmentation level of the at least one optical coat 11 is preferably less than 50%, preferably less than 40%, further preferably less than 30%.

It is also possible for the at least one optical coat 11 to be colorless and/or to be clearly transparent and/or for the pigmentation level of the at least one optical coat 11 to be 0%.

Further, it is also possible for the at least one optical coat 11 to have a gloss value of more than 50 GU, preferably of more than 60 GU, preferably at a measurement angle of 60°, under light, in particular light in the wavelength range of between 300 nm and 780 nm.

The at least one protective varnish layer 33 preferably comprises a material or a combination of materials selected from: polymers, in particular acrylate copolymers, polyester copolymers, polystyrene copolymers, polycarbonate copolymers and/or SMA copolymers.

The at least one protective varnish layer 33 preferably has a thickness in the range of from 0.5 μm to 3 μm, in particular of from 0.8 μm to 1.3 μm.

Alternatively, the protective varnish layer 33 can act as a detachment layer. The force of detachment of the protective varnish layer 32 from the carrier ply preferably lies between 5 cN and 45 cN, further preferably between 10 cN and 30 cN.

It is preferably possible for the at least one protective varnish layer 32 to be formed transparent or translucent or opaque and/or dyed or at least partially dyed and/or crystal clear.

The protective varnish layer 33 in particular represents a protection from chemical, physical and/or mechanical stress of the at least one decorative ply on the substrate.

In particular, the at least one adhesive layer 32 of the at least one decorative ply 30 can have the features already listed for the at least one adhesive layer 22 of the protective ply 20.

It is further preferably provided that the at least one adhesive layer 22 covers the at least one decorative ply 30 from the top and/or bottom side at least partially or over the whole surface.

In a preferred embodiment, it is provided that the at least one adhesive layer 32 of the at least one decorative ply 30 and the at least one adhesive layer 22 of the at least one protective ply 20 are different in terms of their chemical and/or physical properties.

In order, in particular when a UV adhesive is used as cold glue, to achieve the desired high UV transmissibility of the at least one decorative ply also in the case of at least one decorative layer in the form of a metallic layer, it is particularly preferred if the metallic layer has merely a layer thickness in the range of from 8 nm to 60 nm, preferably in the range of from 10 nm to 30 nm.

Thus, a good visibility and decorative effect of the metallic layer in combination with a high transmissibility for UV radiation are achieved, wherein the at least one metallic layer preferably has an OD of 1.2.

In order to achieve a sufficient curing of a UV adhesive, it is provided in particular that the at least one decorative layer has a transmissibility for UV radiation, in particular for the wavelength range of from 250 nm to 400 nm, in the range of from 5% to 70%, in particular of from 10% to 40%.

For example, the substrate 10 of the embodiment example shown in FIG. 2 is an approx. 20 cm×30 cm large piece of a sheet of paper, from Sappi (type: Magno Gloss Arctic White, 200 g/m₂), which is prepared as described in step a1). Further, an optical coat 11, which is dyed for example by means of dyes with a pigmentation level of 10%, with the result that the substrate 10 has a red color impression, is preferably applied to the substrate 10.

A transfer film, prepared according to step a2) and comprising a carrier ply and a decorative ply 30, is applied corresponding to step a3) to the substrate 10 by means of a flat stamp (brass stamp from Hinderer & Mühlich, dimensions 7 cm×10 cm) and a manual stamping machine (Gierlich P5000, temperature at the stamp 119° C.). The decorative ply 30 comprises for example a silver hot-stamping film (LUXOR MTS Alufin) as decorative layer 31, which lies between a protective varnish layer 33 and an adhesive layer 32. The protective varnish layer 33 adjoining the carrier ply is for example made of a transparent and 1 μm thick acrylate copolymer. The adhesive layer 32 of the decorative ply preferably comprises in particular polyester copolymers, acrylate copolymers, polyvinyl chlorides, chlorinated polyolefins, ketone-aldehyde resins, colophony resins, hydrocarbon resins, polyamide resins.

In particular, the carrier ply comprises a material or a combination of materials selected from: PET, PMMA, PC, PE, PVC, PS, ABS, PU, PBS, PLA, PAN and/or glass and/or paper and/or hybrid materials. The carrier ply is peeled off corresponding to step a4) after the substrate 10 has been decorated, wherein the protective varnish layer 33 acts as a detachment layer, with the result that the complete layer structure of the decorative ply 30 remains on the substrate 10. Thus, as in step a), a substrate 10 provided with a decorative ply 30 is obtained.

In an embodiment, the prepared transfer film further has at least one detachment layer.

The at least one detachment layer preferably comprises a material or a combination of materials selected from: waxes, silicones, polyurethanes and/or polymers, preferably acrylate copolymer, polyester copolymers, polystyrene copolymers, polycarbonate copolymers.

The at least one detachment layer of the at least one detachment layer preferably has a thickness in the range of from 0.01 μm to 0.50 μm.

In particular, it is advantageous if at least one detachment layer is formed transparent or translucent or opaque and/or dyed or at least partially dyed and/or crystal clear.

For example, a transparent paper from Canson with a grammage of 70 g/m₂ is is prepared as protective layer 21 of the protective ply 20. Analogously to the protective ply 20 according to FIG. 1, an adhesive layer 22 is applied to the protective layer 21 and dried in such a way that it preferably forms a closed layer on the transparent paper. This preferably corresponds to step b) of the method according to FIG. 10.

Analogously to FIG. 1, the protective ply 20 is laminated, corresponding to step c), on the decorated substrate by means of a roll-off method preferably over the whole surface. The protective ply 20 protrudes beyond the decorative ply 30 in particular by 3 cm in every lateral direction.

A sectional representation of an embodiment variant of the multilayer body 1, as represented in FIG. 2, is described in FIG. 3, comprising a substrate 10, at least one decorative ply 30 and at least one protective ply 20. In addition, the at least one decorative ply 30 is present in an area 40a and is not present in another area 40b. The substrate 10 is preferably visible for an observer through the at least one protective ply 20 in a top view.

The at least one decorative ply 30 preferably comprises at least one adhesive layer 32, at least one decorative layer 31 and at least one protective varnish layer 33. In particular, the at least one decorative ply 30 has at least one color layer 34 which, as shown in FIG. 3, is in particular attached to the side of the at least one protective varnish layer 33 facing the protective ply 20. A glossy, dyed optical coat 11, which faces the decorative ply 30, is preferably applied to the substrate 10.

The at least one decorative ply 30 likewise has at least one or more primer layers 35, which can be different in terms of their chemical and/or physical properties, with the result that a sufficient adhesion to the layers adjoining the primer layer 35, in particular to an adjoining adhesive layer 32, is formed. Thus, it is possible for example to achieve a sufficient adhesion in the direction of the at least one decorative layer 31 on one side of the primer layer 35 and a sufficient adhesion in the direction of the at least one adhesive layer 32 on the other side of the primer layer 35.

It is preferably provided that the at least one primer layer 35 has a thickness in the range of from 0.1 μm to 2 μm, preferably of from 0.2 μm to 1 μm, further preferably of from 0.2 μm to 0.8 μm.

In particular, the at least one primer layer 35 is formed transparent or translucent or opaque and/or dyed or at least partially dyed and/or crystal clear.

It is further preferably provided that at least one primer layer 35 has a surface roughness in the range of from 100 nm to 200 nm, preferably of from 120 nm to nm.

At least one decorative layer 31 preferably has at least one, preferably patterned, reflective layer, further preferably designed in the form of a first item of information.

In particular, it is provided that the at least one color layer 34 is preferably shaped patterned, further preferably in the form of a second item of information. The second item of information can be identical to, in particular congruent with, the first item of information. The second item of information can alternatively be different from the first item of information.

By information is meant in particular the representation of one of the following design elements or a combination of the following design elements: alphanumeric character, character, symbol, microprint, image, motif, photo, logo, portrait, pictogram. Further, it possible for the information to be represented in the form of an endless pattern and/or a grid, in particular a periodic grid, aperiodic grid, random grid, amplitude-modulated grid, dot grid, line grid.

In particular, it is possible for the at least one color layer 34 to be an overprint. This means here that the at least one color layer 34 is applied as an overprint to the side of the at least one protective varnish layer 33 facing the protective ply 20. The color layer 34 is preferably applied as an overprint after the the further layers comprised by the decorative ply 30 have already been applied to the substrate 10.

Further, it is preferred that the at least one color layer 34 is dyed by means of dyes and/or pigments, wherein the pigmentation level of the at least one color layer 34 is preferably between 1% and 50%, preferably between 10% and 30%.

In particular, it is preferred that the at least one color layer 34 has a layer thickness of between 0.5 μm and 10 μm, preferably between 1 μm and 5 μm. It is further preferred that the at least one color layer 34 is deposited as a varnish and the preferred layer thickness is understood as the dry layer thickness.

It is particularly preferred that the at least one color layer 34 is multilayered, in particular that the at least one color layer 34 is formed of two or more partial layers, wherein the two or more partial layers preferably in each case have a layer thickness of between 0.1 μm and 2 μm, further preferably between 0.3 μm and 1 μm.

Furthermore, it is also possible for the at least one color layer 34 to be formed over the whole surface, in particular for the at least one color layer 34 to occupy the entire surface area of the at least one decorative ply 30 when viewed in a top view.

It is also preferred that the at least one color layer 34 has a transmittance of more than 10%, preferably of more than 25%, further preferably of more than 50%, still further preferably of more than 75%, furthermore still further preferably of more than 90%, in particular in the wavelength range of between 300 nm and 780 nm.

It is further preferably provided that the force of adhesion between the at least one color layer 34 and the at least one decorative ply 30 is at least 25 cN, preferably at least 30 cN.

In particular, it is also possible for at least one area 40a, 40b and/or all areas to be designed patterned, in particular in the form of at least one of the following design elements or a combination of the following design elements: alphanumeric character, character, symbol, microprint, image, photo, motif, logo, portrait, pictogram.

Further, it is also possible for at least one area 40a, 40b to be designed in the form of an endless pattern and/or grid, in particular a periodic grid, aperiodic grid, random grid, amplitude-modulated grid, dot grid, line grid.

For a further embodiment variant, a multilayer body 1 is represented in FIG. 4 in its sectional representation. Like the multilayer body 1 according to FIG. 2, this comprises in particular a substrate 10, comprising at least one optical coat 11, at least one decorative ply 30 and at least one protective ply 20.

Further, the decorated substrate preferably has in each case open areas in the substrate 10 and the at least one decorative ply 30. In other words, the decorated substrate is designed in such a way that there are areas 40c in which in each case the at least one decorative ply 30 and a substrate 10 are present and areas 40d in which in each case no decorative ply 30 and no substrate 10 are present. In the embodiment shown, see-through areas form in particular in the case of transparent protective plies 20 in a top view.

A further embodiment for a multilayer body 1 is shown in the sectional representation in FIG. 5. Here, an area 40e of the substrate 10, comprising at least one optical coat 11, is preferably decorated with the at least one decorative ply 30 and an area 40f of the substrate 10 is not decorated by the at least one decorative ply 30. Further, it is possible for at least one protective ply 20 to be applied in the area 40e and no protective ply 20 to be applied in the area 40f. Thus, the design of the substrate 10 is visible for an observer in a top view in area without being influenced by the at least one protective ply 20. In other words, the color and the gloss of the substrate 10 can be perceived for example without a soft-focus effect.

The embodiment variants of FIG. 6 and FIG. 7 in each case show a sectional representation of a further multilayer body 1 according to FIG. 2, wherein the multilayer body 1 has at least two protective plies 20a, 20b. The at least two protective plies 20a, 20b in each case comprise at least one protective ply 21a, 21b and at least one adhesive layer 22a, 22b.

The multilayer body of FIG. 6 further has areas 40g which are recognizable in a top view for the observer and in which at least one protective ply 20a preferably has different properties from at least one protective ply 20b in another area 40h. For example, the protective plies 20a, 20b can differ in particular by pigmentation level and/or type of pigments and/or transmittance and/or color and/or cloudiness and/or image sharpness and/or thickness. The at least two protective plies 20a, 20b have in particular in each case the preferred embodiments of the at least one protective ply 20 shown in FIG. 1. Further, it is conceivable that these areas 40g, 40h at least partially overlap.

The sectional representation of the multilayer body 1 according to FIG. 7 represents a supplement or alternative to this. In a top view, areas 40i in which at least one further protective ply 20b is preferably applied at least partially to at least one protective ply 20a are recognizable for the observer. In particular, no protective ply 20b is applied in the areas 40j recognizable for the observer, with the result that only the at least one protective ply 20a is visible there. Here too, as in FIG. 6, it is possible for the protective plies 20a, 20b to differ in terms of their properties and preferably to have the preferred embodiments of the at least one protective ply 20 shown in FIG. 1.

The appearance of the multilayer body 1 can be influenced thereby and for example a transition from a purely yellow area to a purely red area can be made possible, wherein an orange mixed color is visible in particular where the areas overlap. It is also provided to generate, through the overlapping of protective plies, areas which have a stronger soft-focus effect or a greater cloudiness than other areas arranged next to them.

A further embodiment variant of a multilayer body 1 according to FIG. 2 is shown in FIG. 8 using a schematic sectional representation. The multilayer body 1 here has a substrate 10, to which at least one decorative ply 30a is applied. Further, it is possible to apply at least one further decorative ply 30b to the at least one decorative ply 30a applied to the substrate 10 over the whole surface or at least partially.

For example, the at least one decorative ply 30a comprises at least one decorative layer 31a and at least one adhesive layer 32a and the at least one further decorative ply 30b comprises at least one decorative layer 31b, at least one adhesive layer 32b and at least one protective varnish layer 33.

At least one protective ply 20 is preferably applied as a sealing layer to the visible side of the multilayer body 1, preferably over the whole surface. It is possible for the at least one further decorative ply 30b to be designed in such a way that it is transmissible for at least partial ranges of the light spectrum visible to the human eye, in particular in the wavelength range of between 300 nm and 780 nm. Through this embodiment variant of the multilayer body 1, it is possible for the observer to recognize, in a top view onto the visible side of the multilayer body 1, areas 40l the optical appearance of which is influenced by the at least one decorative ply 30a in contact with the substrate 10 and areas 40k which are influenced by the at least one further decorative ply 30b.

Of course, the listed embodiment variants, in particular with respect to the layer structure of the multilayer body 1, can be combined with each other as desired and do not represent a limitation.

Schematic results of a test for determining the adhesion of a multilayer body 1, for example according to FIG. 1 to FIG. 8, are shown in top view in FIG. 11a to FIG. 11d.

The adhesion is preferably determined by means of a cross-cut test DIN EN ISO 2409:2013-06 and/or ASTM D3359-09. The resulting sectional image is preferably assessed visually and allocated a characteristic value. Characteristic values corresponding to the standard of between GT 0 or 5 B, stands for a good adhesion, and GT 5 or 0 B, for a poor adhesion, preferably result.

In the cross-cut tests represented in FIG. 11a to FIG. 11d, the adhesion decreases from FIG. 11a to FIG. 11d. No cross-cut tests are shown for the respectively highest and lowest characteristic value.

The multilayer body 1, for example according to FIG. 1 to FIG. 8, preferably has a characteristic value of GT 0 or 5 B.

### LIST OF REFERENCE NUMBERS

1 multilayer body
10 substrate
11 optical coat
20, 20a, 20b protective ply
21, 21a, 21b protective layer
22, 22a, 22b adhesive layer
30, 30a, 30b decorative ply
31, 31a, 31b decorative layer
32, 32a, 32b adhesive layer
33, 33b protective varnish layer
34 color layer
35 primer layer
40a, 40b, 40 areas
40d, 40e, 40f,
40g, 40h, 40i,
40j, 40k, 40l

1. A multilayer body, comprising a substrate, at least one decorative ply and at least one protective ply, wherein the at least one protective ply has at least one protective layer and at least one adhesive layer, and wherein
the at least one protective layer comprises or consists of paper.

2. The multilayer body according to claim 1, wherein
the substrate comprises a material which is selected from the group which consists of paper, card and mixtures thereof.

3. The multilayer body according to claim 1, wherein
the at least one protective layer has a transmittance of at least 50%.

4. The multilayer body according to one of the claim 1, wherein the at least one protective layer has an image sharpness value of from at least 0.5% to 10%.

5. The multilayer body according to claim 1, wherein
the at least one protective layer has a grammage in the range of from 5 g/m₂ to 300 g/m².

6. The multilayer body according to claim 1, wherein,
the at least one protective ply is applied register-accurately to the decorative ply.

7. The multilayer body according to claim 1, wherein
the multilayer body has at least two protective plies wherein these differ.

8. The multilayer body according to claim 1, wherein
the multilayer body has at least two protective plies which are present next to each other, viewed perpendicularly from the visible side.

9. The multilayer body according to claim 1, wherein
the multilayer body has at least two protective plies, which are present one over another and/or overlapping at least in areas, viewed in a top view.

10. The multilayer body according to claim 1, wherein
the at least one protective layer is dyed.

11. The multilayer body according to claim 1, wherein
the at least one protective layer is not dyed and/or the pigmentation level of the at least one protective layer is less than 5%.

12. The multilayer body according to claim 1, wherein
the at least one decorative ply is applied register-accurately to the substrate.

13. The multilayer body according to claim 1, wherein
the at least one decorative ply comprises at least one primer layer.

14. (canceled)

15. The multilayer body according to claim 1, wherein the at least one decorative ply has at least one adhesive layer.

16. The multilayer body according to claim 15, wherein
the at least one adhesive layer of the at least one decorative ply and/or the at least one adhesive layer of the at least one protective ply is formed of a hot glue and/or a thermoplastic adhesive and/or a cold glue and/or a radiation-curable adhesive.

17. The multilayer body according to claim 15, wherein
the at least one adhesive layer of the at least one decorative ply and/or the at least one adhesive layer of the at least one protective ply has a non-volatile proportion in the range of from 5 wt.-% to 70 wt.%, relative to the total weight of all constituents of the respective adhesive layer.

18. The multilayer body according to claim 15, wherein
the at least one adhesive layer of the at least one decorative ply and/or the at least one adhesive layer of the at least one protective ply comprises or consists of polyester resins.

19. The multilayer body according to claim 15, wherein
the at least one adhesive layer of the at least one decorative ply and/or the at least one adhesive layer of the at least one protective ply has a thickness in the range of from 1 μm to 20 μm.

20. The multilayer body according to claim 15, wherein
the at least one adhesive layer of the at least one decorative ply and/or the at least one adhesive layer of the at least one protective ply has a softening range in a range of between 40° C. and 180° C., further preferably between 60° C. and 140° C.

21. (canceled)

22. The multilayer body according to claim 1, wherein
the substrate has a grammage in the range of from 50 g/m₂ to 500 g/m₂.

23. The multilayer body according to claim 1, wherein
the substrate has a surface smoothness in the range of from 0.5 μm to 8.0 μm, measured using the Parker Print-Surf method, and/or a surface smoothness in the range of from 50 ml/min to 900 ml/min, measured using the Bendtsen method.

24. The multilayer body according to claim 1, wherein the substrate comprises at least one optical coat.

25. The multilayer body according to claim 24, wherein
the at least one optical coat is dyed.

26. The multilayer body according to 24, wherein
the at least one optical coat is colorless and/or is clearly transparent and/or in that the pigmentation level of the at least one optical coat is less than 5%.

27. The multilayer body according to claim 24, wherein
the at least one optical coat has a gloss value of more than 50 GU.

28. The multilayer body according to claim 1, wherein
the at least one decorative ply has at least one protective varnish layer.

29. The multilayer body according to claim 1, wherein
the multilayer body has at least two decorative plies.

30. The multilayer body according to claim 1, wherein
at least two, decorative plies are present next to each other.

31. The multilayer body according to claim 1, wherein
at least two decorative plies are present at least partially one over another and/or overlapping.

32. The multilayer body according to claim 1, wherein
the at least one decorative ply has at least one decorative layer.

33. (canceled)

34. The multilayer body according to claim 32, wherein
the at least one decorative layer has a gloss value of 100 GU or more.

35. The multilayer body according to claim 32, wherein
the at least one decorative layer has at least one layer generating an optically variable effect.

36. The multilayer body according to claim 32, wherein
the at least one decorative layer has at least one replication varnish layer with a surface structure molded into the at least one replication varnish layer.

37. The multilayer body according to claim 32, wherein
the at least one decorative layer has at least one, preferably patterned, reflective layer.

38. The multilayer body according to claim 32, wherein
the at least one decorative layer has at least one thin-film layer element for generating a color shift effect dependent on the viewing angle.

39. The multilayer body according to claim 32, wherein
the at least one decorative layer is formed of a High Refractive Index material.

40. The multilayer body according to claim 32, wherein
the at least one decorative layer has a transmissibility for UV radiation in the range of from 5% to 70.

41. The multilayer body according to claim 32, wherein
the at least one decorative layer has at least one metallic layer and/or at least one dielectric layer.

42-43 (canceled)

44. The multilayer body according to claim 1, wherein
the at least one decorative ply has at least one color layer.

45. The multilayer body according to claim 44, wherein
the at least one color layer is dyed by means of dyes and/or pigments.

46. (canceled)

47. The multilayer body according to claim 44, wherein
the at least one color layer is multilayered.

48. The multilayer body according to claim 44, wherein
the at least one color layer is formed over the whole surface, viewed in a top view.

49. The multilayer body according to claim 44, wherein
the at least one color layer has a transmittance of more than 10%.

50-54 (canceled)

55. The multilayer body according to claim 1, wherein
the at least one protective ply forms the visible side of the multilayer body.

56-59. (canceled)

60. A method for producing a multilayer body wherein the method comprises the following steps:
a) preparing a substrate provided with at least one decorative ply,
b) preparing at least one protective ply, wherein the protective ply comprises at least one protective layer and at least one adhesive layer, wherein the at least one protective layer comprises or consists of paper,
c) applying the at least one protective ply to the substrate provided with the at least one decorative ply.

61. The method for producing a multilayer body according to claim 60, wherein
step a) further comprises the following steps:
a1) preparing the substrate,
a2) preparing the at least one decorative ply as a transfer ply of a transfer film, wherein the transfer film further comprises a carrier ply and the transfer ply,
a3) applying the at least one decorative ply to the substrate in at least one partial area,
a4) peeling off the carrier ply.

62. The method for producing a multilayer body according to claim 61, wherein
the substrate prepared in step a) comprises at least one optical coat.

63. The method for producing a multilayer body according to claim 61, wherein
the transfer film prepared in step a2) as a decorative ply has at least one detachment layer.

64. The method for producing a multilayer body according to claim 63, wherein
the at least one detachment layer comprises a material or a combination of materials which is selected from the group waxes, silicones, polyurethanes and/or polymers.

65. (canceled)

66. The method for producing a multilayer body according to claim 63, wherein
the at least one detachment layer is formed transparent or translucent or opaque and/or dyed or at least partially dyed and/or crystal clear.

67. The method for producing a multilayer body according to claim 61, wherein
the application of the at least one decorative ply to the substrate is effected by means of one of the following methods: stamping or lamination.

68-71. (canceled)
